(19) United States
(12) Patent Application Publication
(10) Pub. No.: US 2018/0324849 A1
(43) Pub. Date: Nov. 8, 2018

(54) REVERSE DIRECTION PROTOCOL ENHANCEMENTS

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Alireza RAISSINIA, Monte Sereno, CA (US)

(21) Appl. No.: 15/968,554

(22) Filed: May 1, 2018

Related U.S. Application Data
(60) Provisional application No. 62/501,704, filed on May 4, 2017.
(60) Provisional application No. 62/501,030, filed on May 3, 2017.

(51) Int. Cl. H04W 72/14; H04W 74/02

(52) U.S. Cl. CPC H04W 72/14; H04W 84/12; H04W 74/02

(57) ABSTRACT

Methods, apparatuses, and computer-readable mediums for wireless communication are provided. In an aspect, a second device is configured to receive, from a first device, a reverse direction (RD) grant associated with first device. The RD grant allocates transmission opportunity (TXOP) resources to the second device from the first device. In addition, the second device is configured to send information to the first device indicating an amount of TXOP resources that the second device intends to use.

### CROSS-REFERENCE TO RELATED APPLICATION(S)

This application claims the benefit of U.S. Provisional Application Ser. No. 62/501,704, entitled “REVERSE DIRECTION PROTOCOL ENHANCEMENTS” and filed on May 4, 2017 and U.S. Provisional Application Ser. No. 62/501,030, entitled “REVERSE DIRECTION PROTOCOL ENHANCEMENTS” and filed on May 3, 2017, which are expressly incorporated by reference herein in their entirety.

### BACKGROUND

### Field

The present disclosure relates generally to communication systems, and more particularly, to enhancements for a reverse direction protocol in a communication system.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

A reverse direction grant enables a first device (reverse direction (RD) initiator) to allocate some of the transmission opportunity (TXOP) resources to a second device (peer station (STA)/RD responder), but there is no mechanism for the second device to indicate to the first device the amount of TXOP that the second device would use. In an aspect, the second device indicates a requested duration using existing fields in the IEEE 802.11ax standard. In an aspect the second device can keep the TXOP for sending a first frame or subsequent frames of an RD response burst when the second device sends a frame with an RD grant (RDG)/More physical layer convergence protocol (PLCP) protocol data unit (PPDU) set to 1 or “true,” and short interframe space (SIFS) after the preceding frame. However if an acknowledgment (Ack)/Block acknowledgment (Block Ack) is solicited by the second device, then the first frame may have to be an Ack/Block Ack that is wrapped in a control wrapper frame (which is not allowed in IEEE 802.11ax standard). In an aspect, the second device is permitted to aggregate another frame (e.g., a quality of service (QoS) Null frame) with the control response (Ack/Block Ack) to retain control of the TXOP.

### BRIEF DESCRIPTION OF THE DRAWINGS

FIG. 1 is an example wireless communication system in which aspects of the present disclosure may be employed.

FIG. 2 is an example a control information subfield format according to aspects of the present disclosure.

FIG. 3 is an example of a reverse direction (RD) exchange sequence according to aspects of the present disclosure.

FIG. 4 is an example of a RD exchange request being performed according to aspects of the present disclosure.

FIG. 5 is a flowchart of an exemplary method of wireless communication.

FIG. 6 is a flowchart of an exemplary method of wireless communication.

FIG. 7 is a flowchart of an exemplary method of wireless communication.

FIG. 8 is a flowchart of an exemplary method of wireless communication.

FIG. 9 shows an example functional block diagram of a wireless device.

### DETAILED DESCRIPTION

Various aspects of the systems, apparatuses, computer-readable media, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an IEEE 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations, a STA may also be used as an AP.

An access point may also comprise, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, Multiple-Input Multiple-Output (MIMO) schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams, and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

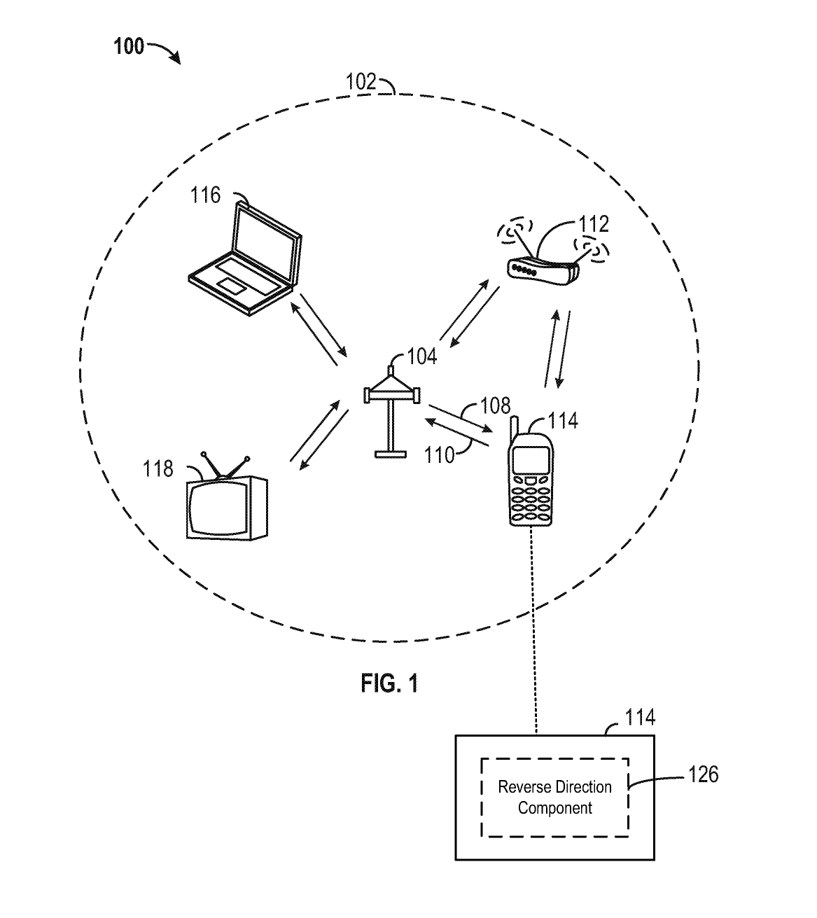

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

Typically, an RD responder using reverse direction (RD) protocol maintains an RD grant by relying on settings in an RD grant (RDG)/More physical layer convergence protocol (PLCP) protocol data unit (PPDU) subfield of a control field. However, a control frame that would be sent in response to the RD grant generally does not contain an RDG/more PPDU subfield. Accordingly, techniques are needed to allow an RD responder to aggregate frames (e.g., media access control protocol data unit (MPDU)) together with a transmitted control frame so that the RD responder may maintain ownership of the RD grant. In some aspects, the STA 114 may include a reverse direction (RD) component 126. The RD component 126 may be configured to receive an RD grant associated with an RD initiator, the RD grant allocating transmission opportunity (TXOP) resources to the RD responder from the RD initiator; and transmit, in response to receiving the RD grant, a control response aggregated with at least one media access control protocol data unit (MPDU).

In another aspect, the RD component 126 may be configured to receive an RD exchange request from an RD initiator, the RD exchange request indicating to the RD responder to initiate an RD exchange sequence; and transmit, in response to the RD exchange request, an RD grant to the RD initiator. In one aspect, the response to the RD exchange request may be an RD exchange response that indicates whether the request is accepted or declined by the potential RD initiator.

In another aspect, the RD component 126 may be configured to transmit an RD grant associated with the RD initiator, the RD grant allocating transmission opportunity (TXOP) resources to an RD responder from the RD initiator. The RD component may receive, in response to the RD grant, a control response aggregated with at least one media access control protocol data unit (MPDU) and determine whether the RD grant is accepted or declined based on the MPDU.

In another aspect, the RD component 126 may be configured to transmit an RD exchange request to an RD responder, the RD exchange request indicating to the RD responder to initiate an RD exchange sequence; and receive, in response to the RD exchange request, an RD grant from the RD responder.

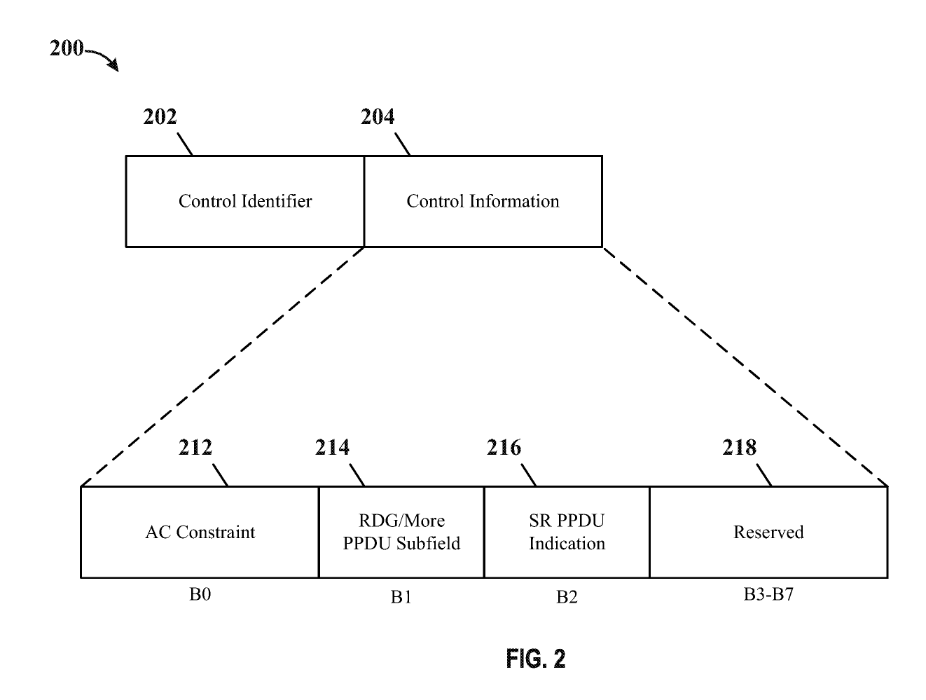

FIG. 2 illustrates a control field 200 according to aspects of the present application.

The control field 200 may be a field within a frame control of a MAC frame. The control field 200 may include a control identifier subfield 202 and a control information subfield 204. The control identifier 202 may indicate the type of information carried by the control information subfield 204. Further, the format and the number of bits of the control information subfield 204 may be based on the type of information carried in the control information subfield 204. In some examples, the control identifier 202 may indicate that the control information subfield 204 contains a command and status (CAS) indication. For example, the control identifier 202 may indicate that the control information subfield 204 contains a CAS indication when the control identifier subfield is equal to 6. A format of the control information subfield 204 may include, when the control identifier 202 includes the CAS indication, an access category (AC) constraint subfield 212, a reverse direction (RD) grant (RDG)/More physical layer convergence protocol (PLCP) protocol data unit (PPDU) subfield 214, a spatial reuse (SR) PPDU Indication subfield 216, and a reserved subfield 218. In an example, the control information subfield 204 may be 8 bits long, as shown by FIG. 2.

The AC constraint subfield 212 may indicate to a STA that a response to a RD grant contains RD data frames having the same AC or an AC that is higher. For example, the AC constraint subfield 212 may include a value of 1 to indicate to the STA that a response from the STA contains RD data frames having the same AC or higher ACs.

The RDG/More PPDU subfield 214 may indicate to a STA whether another frame immediately follows the frame that was received. For example, the RDG/More PPDU subfield 214 may include a value of 1 to indicate to the STA that one or more frames are being sent immediately following the frame that was just received.

The SR PPDU indication subfield 216 may indicate to a STA whether a PPDU carrying a MAC PDU (MPDU), which in turn is carrying the control field 200, is an SR PPDU. For example, the SR PPDU indication subfield 216 may be set to 1 or “true” when the PPDU is an SR PPDU; otherwise the SR PPDU indication subfield 216 may be set to 0 or “false.”

Reverse Direction Protocol

With respect to the RD protocol, the RD protocol may be supported by the STA 114. In an example, the STA 114 may be a high throughput (HT) STA, a very high throughput (VHT) STA, a high efficiency (HE) STA, or a very high efficiency (VHE) STA. While the STA 114 receives an RD grant (RDG), the STA 114 may not be required to use the RDG.

In an example, the STA 114 may indicate support of an RD feature as an RD responder in a capabilities element transmitted by the STA 114. For example, the STA 114 may use an RD Responder subfield of an Extended Capabilities field of the capabilities element. The STA 114 may set the RD Responder subfield to 1 or “true” in frames that the STA 114 transmits containing the capabilities element when the RD Responder option is supported. Otherwise, the STA 114 may set the RD responder subfield to 0 or “false”.

RD Exchange Sequence

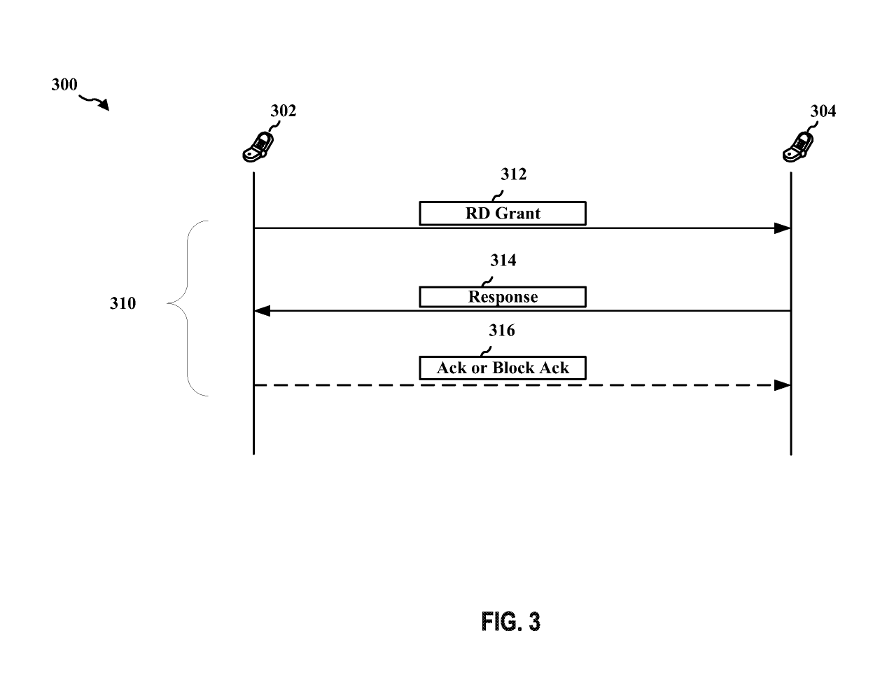

FIG. 3 illustrates an example of an RD exchange sequence 310 between a first device 302 and an second device 304. In this example, the first device 302 may be an RD initiator and the second device 304 may be an RD responder. In an example, the first device 302 and second device 304 may both be STAs or one of them may be a STA and the other may be an AP. Examples of the first device 302 and the second device 304 may include the STA 114 or AP 104 of FIG. 1. Initially, the first device 302 may transmit an RD grant 312. In an example, the RD grant 312 may be within a PPDU. Further, the RD grant 312 may be transmitted during a transmission opportunity (TXOP) or service period (SP). In this example, the first device 302 is the TXOP holder or the device which controls access to channels for data frame transmission. In some examples, the PPDU may also contain one or more MPDUs. In an example, the RD grant 312 may be indicated in the RDG/More PPDU subfield 214. For example, the RDG/More PPDU subfield 214 may be set to 1 or “true” to indicate that an RD grant 312 is present in the frame. The first device 302 may remain as the RD initiator during a single RD exchange sequence 310 or may remain the RD initiator during multiple RD exchanges provided that these RD exchanges are within the TXOP duration or the SP duration. In the example, the first device 302 may remain as the RD initiator after the transmission of an RD grant 312 until the end of a last PPDU being transmitted during the RD exchange sequence 310.

Next, the second device 304 may transmit a response 314 to the RD grant 312. The response 314 may be transmitted in one or more PPDUs. The PPDUs may be transmitted as an RD response burst(s). In an example, the first (or only) PPDU of the RD response burst may contain at most one immediate acknowledgment (Ack) or block acknowledgment (Block Ack) frame. The last (or only) PPDU of the RD response burst may contain any MPDUs requiring a response from the RD initiator, wherein the response is an immediate Ack or Block Ack frame, that may be generated after a short interframe space (SIFS) following the last PPDU. The second device 304 may remain as the RD responder from the time the RD grant 312 is received until the transmission of the response 314 by the second device 304 in which the RDG/More PPDU subfield 214 is set to 0 or “false” to indicate that no more PPDUs will be transmitted.

Next, the first device 302 may transmit an Ack or Block Ack 316 if required by the response 314. In an example, the first device 302 may transmit a PPDU containing the Ack or Block Ack 316 in response to the last PPDU of the RD response burst of the response 314. The response to the last PPDU may be contained in a PPDU that carries the control response along with other MPDUs. In an example, the MPDUs may be addressed to the RD responder, or to other STAs.

In an aspect, the first device 302 may include multiple RD exchange sequences 310 within a single TXOP or SP. Each of the RD exchange sequences 310 may be addressed to one or more RD responders (e.g., one or more STAs). In another example, a single RD responder may receive more than one RD grant during a single TXOP or SP.

In another aspect, if the second device 304 is a very high throughput (VHT) AP, the RD response burst may contain VHT MU PPDUs including a transmission vector (TXVECTOR) parameter NUM_USERS >1. If the second device 304 is an HE AP, the RD response burst may contain HE MU PPDUs including TXVECTOR parameter NUM_USERS >1 and trigger frames.

In another aspect, the first device 302 may request the second device 304 to initiate the RD exchange sequence, as described below.

RD Initiator

The first device 302 may not include the RD grant 312 in an MPDU unless the MPDU carrying the RD grant 312, or every MPDU carrying the RD grant 312, in the case of an aggregate MPDU (A-MPDU), includes: (1) a QoS Data frame having an Ack policy field, unless the Ack policy field includes an indication of a power save multi-poll (PSMP) Ack (i.e., including Implicit Block Ack Request), (2) a BlockAckReq frame related to an HT-immediate Block Ack agreement, or (3) an MPDU not needing an immediate response (e.g., Block Ack under an HT-immediate Block Ack agreement, or Action No Ack).

In some examples, the first device 302 may not include the RD grant 312 within a PSMP sequence which may cause the RD grant 312 to be delivered in a PPDU that does not require an immediate response or which requires an immediate response that is an Ack or a Block Ack frame.

In some examples, the first device 302 may not examine an RD responder field of a potential RD responder. For example, the first device 302, may receive the response 314 from the second device 304 but not examine an RD responder field of the response before deciding whether to send a PPDU having an indication of the RD grant 312 to the second device 304.

In some examples, the first device 302 may be required to examine an +HTC-HT Support field of a potential responder (e.g., second device 304) before deciding whether to send a PPDU having an indication of the RD grant 312 to the potential responder.

In some examples, the first device 302 transmits an MPDU that contains the control field 200 with the RDG/More PPDU subfield 214 set to 1 or “true” to indicate that the duration indicated by a Duration/ID field of a frame is available for the RD response burst and to also indicate a final PPDU (if present).

In some examples, the first device 302 that sets the RDG/More PPDU field 214 to 1 or “true” in a frame transmitted during a TXOP may also set the AC Constraint subfield 212 to 1 or “true.”

RD Responder

The second device 304 may transmit an initial PPDU of an RD response burst of the response 314. In an example, the RD response burst may transmitted a short interframe space (SIFS) after the reception of the RD grant 312. PPDUs in the RD response burst may be separated by SIFS, by reduced interframe spaces (RIFS), or without any separation between the PPDUs.

However, the transmission of the response 314 by the second device 304 does not constitute a new channel access. Instead, the response 314 may be a continuation of the TXOP or SP of the first device 302. In some examples, the second device 304 may ignore a network allocation vector (NAV) when responding to the RD grant 312.

In some examples, the second device 304 may decline the RD grant 312 by (a) not transmitting any frames following the RD grant 312 when no response is otherwise required, (b) transmitting a control response frame with the RDG/More PPDU subfield 214 set to 0 or “false,” (c) transmitting a control response frame that contains no HT Control field, or (d) transmitting a control response frame aggregated with other MPDUs with the RDG/More PPDU subfield 214 set to 0 or “false,” where the nonzero length MPDU delimiter that precedes the control response frame in the A-MPDU has the end of frame (EOF) set to 0 or “false” and the nonzero length MPDU delimiter that precedes the other MPDUs may have the EOF field set to “false” or “true.”

Thus, the second device 304 may aggregate MPDUs together with the control response frame, where the aggregated MPDUs may be one or more QoS Null frames, QoS Data frames, or Management frames that contain the control field 200 having the RDG/More PPDU subfield 214 set to 0 or “false.”

In some examples, the second device 304 may accept the RD grant 312 by (a) transmitting a control response frame with the RDG/More PPDU subfield 214 set to 1 or “true,” or (b) transmitting a control response frame aggregated with other MPDUs (e.g., QoS data, QoS Null, or Management frames) with the RDG/More PPDU subfield 214 set to 1 or “true.”

In an example, the second device 304 may not solicit an immediate response from the first device 302 for the aggregated MPDUs. For example, the second device 304 may have an Ack Policy of QoS Data frames or QoS Null frames set to No Ack or Block Ack such that the first device 302 is not required to respond to the aggregated MPDUs.

In an example, the second device 304 may transmit one or more MPDUs, either individually or aggregated within an A-MPDU, which is at least one of an Ack, Compressed Block Ack, Compressed BlockAckReq, Extended Compressed Block Ack, Extended Compressed BlockAckReq, Multi-STA Block Ack, QoS Data, QoS Null, Trigger, or a Management frame.

In some examples, when the second device 304 receives the RD grant 312 from the first device 302 and the AC constraint subfield 212 is set to 1 or “true,” the second device 304 may (a) when the second device 304 is a non-HE RD responder, transmit data frames of only the same AC is received in a PPDU from the first device 302 or (b) if the second device 304 is an HE RD responder, transmit an A-MPDU with a multi-traffic identification (multi-TID) A-MPDU. When transmitting the A-MPDU, the second device 304 may include MPDUs from one or more ACs that have a priority that is equal to or higher than the lowest priority AC of the MPDU(s) carried in the last PPDU received from the first device 302.

In some examples, the second device 304 may account for UL multi-user (MU) delivery. For example, the second device 304 may transmit the response 314 as an RD response burst containing at least one MPDU. The at least one MPDU may include an Address 1 field that matches a MAC address of the first device 302 or a Trigger frame having a User Info field with an association identifier (AID) field that matches the AID of the first device 302. In this example, the inclusion of traffic to STAs, other than the first device 302, in a VHT MU PPDU, HE MU PPDU, or TB PPDU may not increase the duration of the PPDU beyond that required to transport the traffic to or from the first device 302.

In another aspect, the second device 304 may be configured to not transmit any frame causing a response after SIFS with at least one Address 1 field that does not match the MAC address of the first device 302. The second device 304 may also be configured to not transmit any PPDUs with a channel bandwidth (CH_BANDWIDTH) that is wider than the CH_BANDWIDTH of the PPDU containing the frame(s) that delivered the RD grant 312.

In another aspect, the second device 304 may transmit the response 314 having an RD response burst aggregated with a Trigger frame. In an example, the Trigger frame may be included when the second device 304 has not received an indication from the first device 302 to disable the UL MU. In other words, an indication that the uplink multi-user setting is disabled allows the RD responder to perform an RD operation.

In some examples, when the RD grant 312 requires an immediate Block Ack response, the Block Ack frame may be included in a first PPDU of the response 314.

In some examples, when a PPDU of the response 314 is not the final PPDU of a response burst, the control field 200 carrying the RDG/More PPDU subfield 214 set to 1 or “true” may be present in every MPDU within the PPDU capable of carrying the control field 200. In some examples, the RDG/More PPDU subfield 214 within a QoS control field may be set to 1 or “true” in every MPDU within the PPDU. In some examples, the last PPDU of a response burst may have the RDG/More PPDU subfield 214 set to 0 or “false” in all MPDUs contained in the last PPDU.

In some examples, the second device 304 may not set the RDG/More PPDU subfield 214 to 1 or “true” in any MPDU in a PPDU that contains an MPDU requiring an immediate response. However, if the second device 304 transmits a PPDU that expects a transmission response by the first device 302 after SIFS and no such transmission response is detected, the second device 304 may wait for either another RD grant 312 or a TXOP or SP for the second device 304 before retrying the exchange.

In some examples, after transmitting a PPDU containing one or more MPDUs in which the RDG/More PPDU subfield 214 is set to 0 or “false,” the second device 304 may not transmit any more PPDUs within a current response burst. If an RD-capable STA that is not the TXOP holder or SP source receives a PPDU that does not include an RD grant 312, there is no difference in a response by the RD-capable STA compared to a STA that is not RD-capable.

TXOP Duration Requested Subfield

In an aspect, a TXOP duration requested subfield may be present in QoS Data frames and QoS Null frames. The TXOP duration requested subfield may be an 8-bit field that indicates the duration that a sending STA determines to be needed for a subsequent TXOP for the sending STA. In some examples, the duration may be in units of 32 us. The requested TXOP duration may be for a specified TID or for all TIDs/ACs for which the STA is requesting a TXOP. In an example, a TXOP duration requested subfield set to 0 or “false” may indicate that a subsequent TXOP is not requested for the specified TID in the current SP. In another example, a TXOP duration requested subfield set to a nonzero value N may indicate that a subsequent TXOP is requested and may also indicate the duration of the TXOP. For example, the nonzero value may represent an incremental value of a predetermined time (e.g., 32 us) and the nonzero value N may indicate that the subsequent TXOP is requested for N increments of the predetermined time (N×predetermined time).

Requesting an RD Exchange

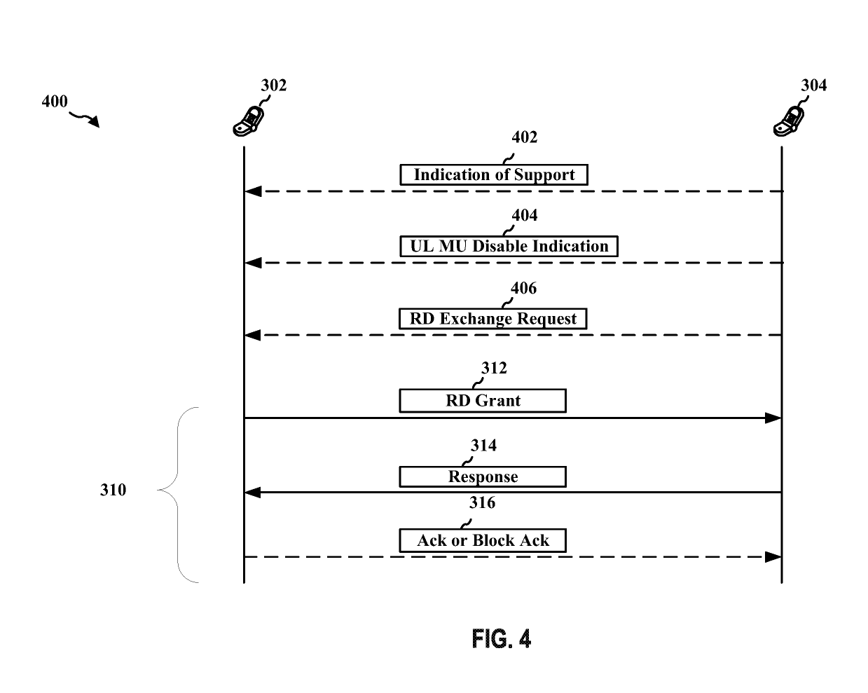

FIG. 4 is an example of a RD exchange request being performed according to aspects of the present disclosure. In an aspect, the second device 304 may optionally request the first device 302 to initiate the RD exchange sequence 310. As shown by FIG. 4, the second device 304 may transmit an RD exchange request 406 to the first device 302 to initiate an RD exchange sequence 310. The second device 304 may transmit the RD exchange request 406 via a QoS Data frame or QoS Null frame. In an example, the QoS Data frame or QoS Null frame may include the TXOP Duration Requested subfield set to a nonzero value N. In some examples, the RD exchange request 406 may be transmitted to the first device 302 if: (a) the second device 304 has indicated support of being an RD Responder in a most recently sent capabilities element and/or (b) the second device 304 has successfully transmitted to the first device 302 a frame containing a control field with the UL MU Disable subfield set to 1 or “true.”

In response to receiving the RD exchange request 406, the first device 302 may confirm the RD exchange request 406 by transmitting a confirmation. In an example, the confirmation may be the RD grant 312, which may also initiate the RD exchange sequence 310 with the second device 304 in a subsequent TXOP. In an example, the subsequent TXOP may have a duration set which is a function of the nonzero value N of the TXOP Duration Requested field. For example the subsequent TXOP may have a duration that accommodates the duration of time needed for the first device 302 to send data to the second device 304, and potentially other devices, plus the duration of time requested by the second device 304. Accordingly, during the RD exchange sequence 310, the response 314 may include an RD response burst having a duration set according to the nonzero value N. In some examples, the first device 302 may initiate multiple RD exchange sequences 310 (which may be limited to one for each TID, one for each AC, or one for each STA that requested a portion of the subsequent TXOP). In some examples, the second device 304 may account for the multiple RD exchange sequences 310 when calculating the duration of an RD response burst, e.g., when the second device 304 sends MPDUs with multiple TIDs as part of the RD response burst. The RD response burst may also contain AC constraints indicated in the AC constraint subfield 212. In some examples the first device 302 may account for multiple TXOP requests received by the same STA or by multiple STAs when calculating the duration of the TXOP, or in other words the number of RD response bursts, and or duration of the RD response bursts.

When the first device 302 responds according to the RD exchange request 406, the first device 302 becomes a candidate for being the RD initiator of a future TXOP and the second device 302 becomes the RD responder, or one of the RD responders.

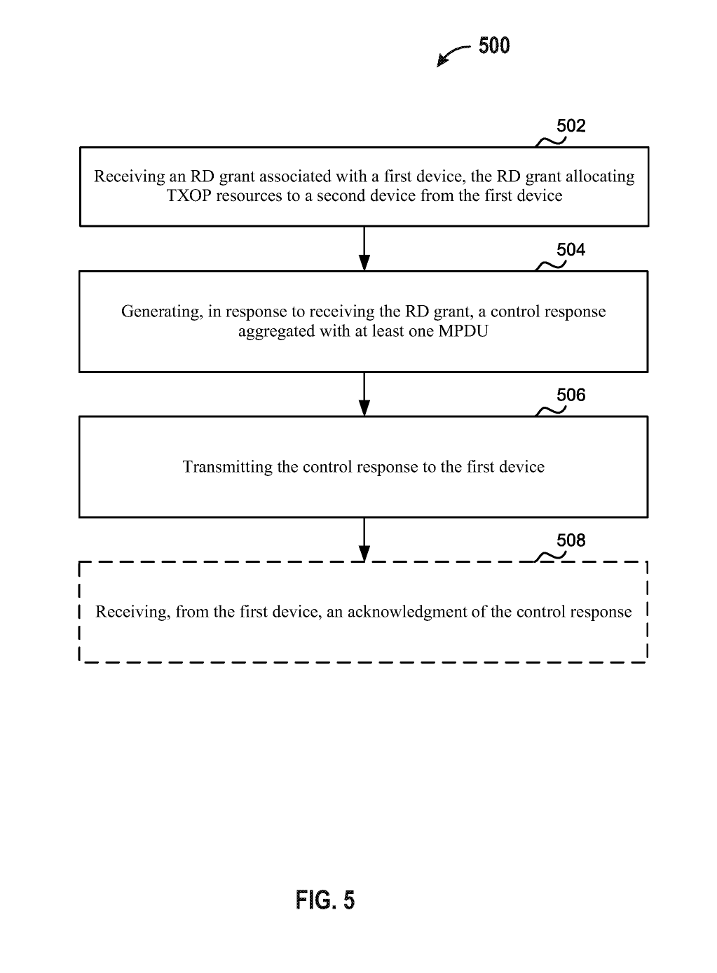

FIGS. 5-8 are flowcharts of methods 500, 600, 700, and 800 of wireless communication. The methods 500, 600, 700, and 800 may be performed by a wireless device (e.g., STA 114 or AP 104). FIG. 5 illustrates the method 500 of performing the RD exchange sequence 310, as shown by FIG. 3, by an RD responder (e.g., second device 304). At block 502, the method 500 may include receiving an RD grant associated with a first device, the RD grant allocating TXOP resources to the second device from the first device. For example, as shown by FIG. 3, the second device 304, acting as an RD responder, may receive the RD grant 312 from the first device 302, which is acting as an RD initiator. In an example, the RD grant 312 may be indicated in the RDG/More PPDU subfield 214, as shown by FIG. 2, and the RD grant 312 may allocate TXOP resources to the second device 304 from the first device 302.

At block 504, the method 500 may include generating, in response to receiving the RD grant, a control response aggregated with at least one media access control protocol data unit (MPDU). For example, as shown by FIG. 3, the second device 304 may generate the response 314, in response to receiving the RD grant 312. In an example, the response 314 may include aggregated MPDUs together with the control response frame. In this example, the aggregated MPDUs may be one or more of the QoS Null frames, QoS Data frames, or Management frames that contain the control field 200. In some examples, the response 314 may be an RD response burst. In some examples, the control field 200 may have the RDG/More PPDU subfield 214 set to 0 or “false” to indicate the that the RD grant is declined or set to 1 or “true” to indicate that the RD grant is accepted. In some examples the RD initiator may perform multiple such sequences with multiple RD responders within the same TXOP or SP.

At block 506, the method 500 may include transmitting the control response to the first device. For example, as shown by FIG. 3, the second device 304 may transmit the response 314 to the first device 302.

At block 508, the method 500 may optionally include receiving, from the first device, an acknowledgment of the control response. For example, as shown by FIG. 3, the second device 304 may receive an Ack or BlockAck from the first device 302 to acknowledge receipt of the response 314.

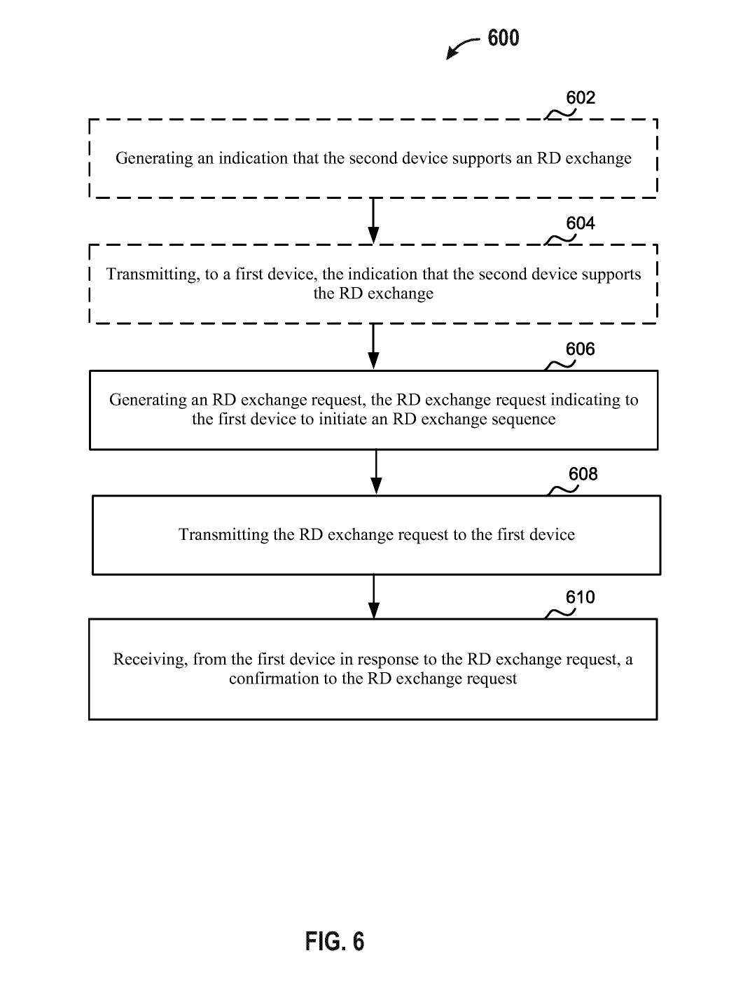

Turning to FIG. 6, the method 600 of performing the RD exchange request by an RD responder (e.g., second device 304), as shown by FIG. 4, is described. At block 602, the method 600 may optionally include generating an indication that the second device supports an RD exchange. For example, as shown by FIG. 4, the second device 304 may generate the indication 402 to indicate that the second device 304 supports an RD exchange. In an example, the indication 402 may be included in an RD responder subfield of an extended capabilities field of a capabilities element. For example, the second device 304 may generate the indication 402 by setting the RD Responder subfield to 1 or “true.” As another example, the second device 304 may generate the indication 404, which indicates that the uplink multi-user setting is disabled. Because the second device 304 disables the uplink multi-user setting, this indicates that the second device 304 supports an RD exchange. As an example, the indication 404 may be within a frame containing a control field 200 with the UL MU Disable subfield equal to 1 or “true.”

At block 604, transmitting, to a first device, the indication that the second device supports the RD exchange. For example, as shown by FIG. 4, the second device 304 may transmit to the first device 302 the indication 402 that the second device 304 supports an RD exchange.

At block 606, the method 600 may include generating an RD exchange request, the RD exchange request requesting the first device to initiate an RD exchange sequence. For example, as shown by FIG. 4, the second device 304 may generate the RD exchange request 406. The RD exchange request 406 may indicate to the first device 302 to initiate the RD exchange sequence 310 in a subsequent TXOP or SP that includes the first device 302. In some examples, the RD exchange request 406 may be indicated in a QoS Data frame or QoS Null frame. In some examples, the RD exchange request 406 may indicate a duration of a TXOP to be used by the first device 302 during an RD exchange sequence. For example, the second device 304 may generate a TXOP duration request in the QoS Data frame or the QoS Null frame. The TXOP duration request may be indicated in a TXOP duration requested field according to a nonzero value N, where the nonzero value N indicates that N increments of a predetermined time (e.g., 32 us) are requested.

At block 608, the method 600 may include transmitting the RD exchange request to the first device. For example, as shown by FIG. 4, the second device 304 may transmit the RD exchange request 406 to the first device 302.

At block 610, the method 600 may optionally include receiving, from the first device in response to the RD exchange request, a confirmation to the RD exchange request. For example, the second device 302 may receive the RD grant 312, in response to the RD exchange request 406, as a confirmation to the RD exchange request 406. In an example the RD grant 312 may be transmitted in a subsequent TXOP or SP. In an example, the second device 312 the confirmation by verifying a PPDU or MPDU having an indication of the RD grant 312.

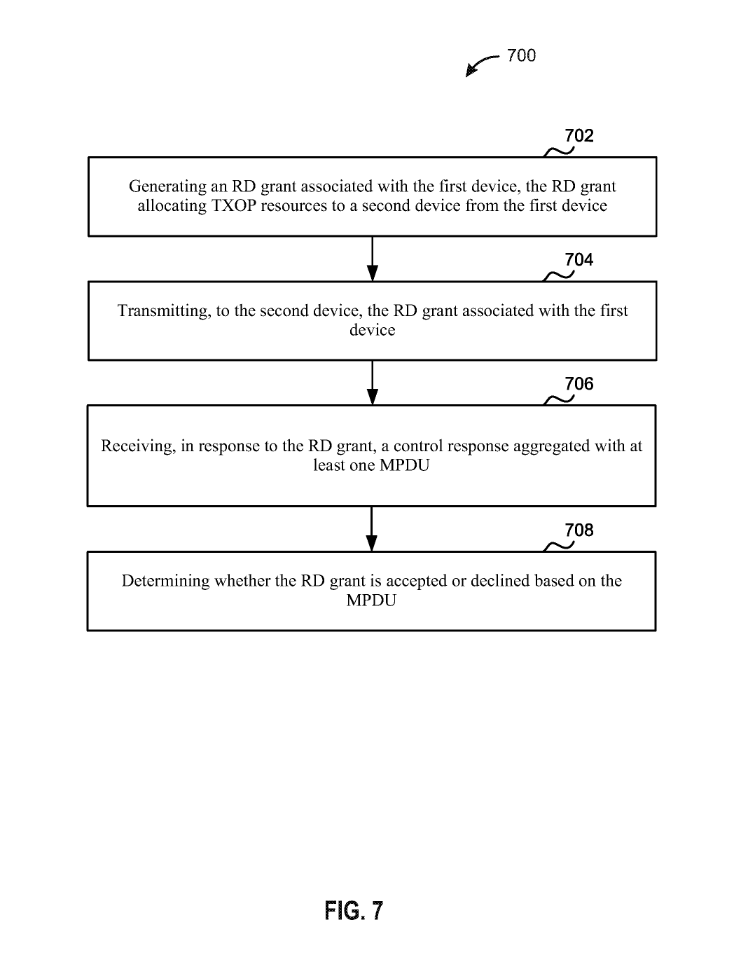

Turning to FIG. 7, the method 700 of performing the RD exchange sequence 310, as shown by FIG. 3, by an RD initiator (e.g., first device 302) is described. At block 702, the method 700 may include generating an RD grant associated with a first device, the RD grant allocating TXOP resources to a second device from the first device. For example, as shown by FIG. 3, the first device 302 may generate the RD grant 312 for the second device 304. In an example, the RD grant 312 may be indicated in the RDG/More PPDU subfield 214, as shown by FIG. 2, and the RD grant 312 may allocate TXOP resources to the second device 304 from the first device 302.

At block 704, the method 700 may include transmitting, to the second device, the RD grant associated with the first device. For example, as shown by FIG. 3, the first device 302 may transmit the RD grant 312 to the second device 304.

At block 706, the method 700 may include receiving, in response to the RD grant, a control response aggregated with at least one media access control protocol data unit (MPDU). For example, as shown by FIG. 3, the first device 302 may receive the response 314 from the second device 304, in response to the RD grant 312. In an example, the response 314 may be a RD response burst. In an example, the response 314 may include aggregate MPDUs together with the control response frame. In this example, the aggregated MPDUs may be one or more of the QoS Null frames, QoS Data frames, or Management frames that each contain the control field 200. In some examples, the response 314 may be an RD response burst.

At block 708, the method 700 may include determining whether the RD grant is accepted or declined based on the MPDU. For example, the first device 302 may determine whether the response 314 indicates that the RD grant 312 is accepted or declined. In some examples, the first device 302 may verify the control field 200 to determine whether the RDG/More PPDU subfield 214 is set to 0 or “false” to indicate the that the RD grant is declined or set to 1 or “true” to indicate that the RD grant is accepted. In some examples the RDG/More PPDU subfield 214 may also indicate that additional PPDUs will be transmitted by the second device 304.

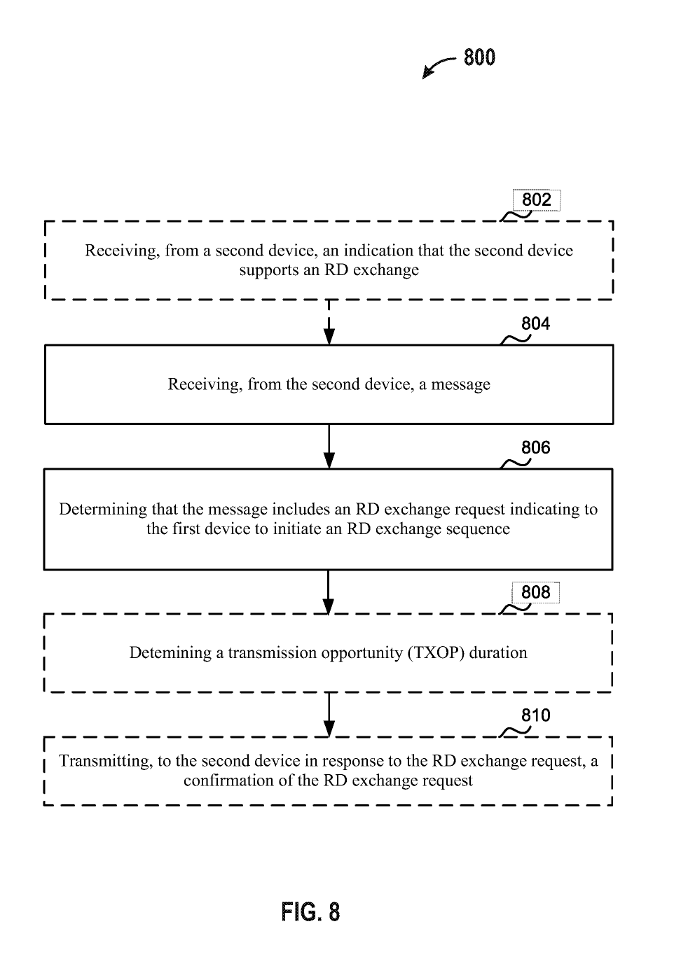

Turning to FIG. 8, a method 800 of performing an RD exchange request by an RD initiator (e.g., first device 302) is described. At block 802, the method 800 may optionally include receiving, from a second device, an indication that the second device supports an RD exchange. For example, the first device 302 may receive, from the second device 304, an indication that the second device 304 supports an RD exchange. In an example, the indication 402 may be included in an RD responder subfield of an extended capabilities field of a capabilities element. For example, the capabilities element may include a RD Responder subfield to 1 or “true” to indicate that that the second device 304 supports an RD exchange. As another example, the first device 302 may receive, from the second device 304, the indication 404 to indicate that the second device 304 supports an RD exchange. The indication 404 may include a setting for an uplink multi-user to be disabled on the second device 304. By disabling the uplink multi-user setting, the second device 304 indicates support for an RD exchange. As an example, the indication 404 may be within a frame containing a control field 200 with the UL MU Disable subfield set to 1 or “true.”

At block 804, the method 800 may include receiving, from a second device, a message. For example, as shown by FIG. 4, the first device 302 may receive the RD exchange request 406 from the second device 304.

At block 806, the method 800 may include determining that the message includes an RD exchange request requesting the first device to initiate an RD exchange sequence. For example, the first device 302 may determine that the message is the RD exchange request 406 by checking a QoS Data frame or QoS Null frame.

At block 808, the method 800 may optionally include determining a duration of a subsequent TXOP. For example, the first device 302 may determine a duration of the TXOP based on the RD exchange request 406. In an example, a duration of the TXOP may TXOP indicated in a TXOP duration request in the QoS Data frame or the QoS Null frame of the RD exchange request 406. The TXOP duration request may be indicated in a TXOP duration requested field according to a nonzero value N, where the nonzero value N indicates that N increments of a predetermined time (e.g., 32 us) are requested.

At block 810, the method 800 may optionally include transmitting, to the second device in response to the RD exchange request, a confirmation of the RD exchange request. For example, the first device 302 may transmit RD grant 312 to the second device 304 in response to the second device 304. In an example, the RD grant 312 may be transmitted in a subsequent TXOP.

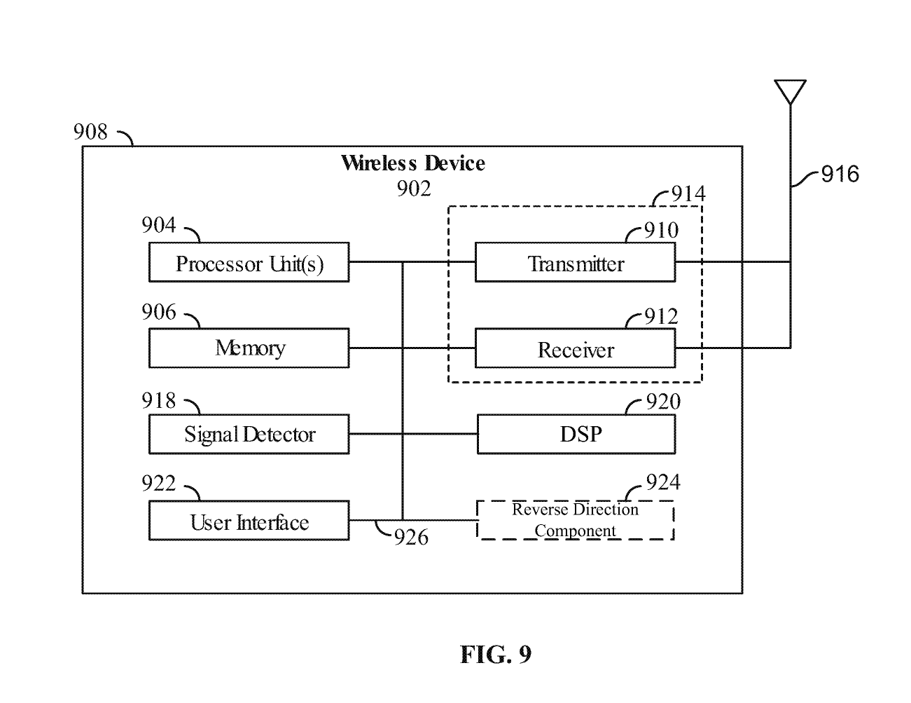

FIG. 9 shows an example functional block diagram of a wireless device 902. The wireless device 902 is an example of a device that may be configured to implement the various methods described herein. For example, the wireless device 902 may be an example of the STA 114 or the AP 94.

The wireless device 902 may include a processor 904, which controls operation of the wireless device 902. The processor 904 may also be referred to as a central processing unit (CPU). Memory 906, which may include both read-only memory (ROM) and random access memory (RAM), may provide instructions and data to the processor 904. A portion of the memory 906 may also include non-volatile random access memory (NVRAM). The processor 904 typically performs logical and arithmetic operations based on program instructions stored within the memory 906. The instructions in the memory 906 may be executable (by the processor 904, for example) to implement the methods described herein.

The processor 904 may comprise or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 902 may also include a housing 908, and the wireless device 902 that may include a transmitter 910 and/or a receiver 912 to allow transmission and reception of data between the wireless device 902 and a remote device. The transmitter 914 and the receiver 912 may be combined into a transceiver 914. An antenna 916 may be attached to the housing 908 and electrically coupled to the transceiver 914. The wireless device 902 may also include multiple transmitters, multiple receivers, multiple transceivers, and/or multiple antennas.

The wireless device 902 may also include a signal detector 918 that may be used to detect and quantify the level of signals received by the transceiver 914 or the receiver 912. The signal detector 918 may detect such signals as total energy, energy per subcarrier per symbol, power spectral density, and other signals. The wireless device 902 may also include a DSP 920 for use in processing signals. The DSP 920 may be configured to generate a packet for transmission. In some aspects, the packet may comprise a physical layer convergence procedure (PLCP) protocol data unit (PPDU).

The wireless device 902 may further comprise a user interface 922 in some aspects. The user interface 922 may comprise a keypad, a microphone, a speaker, and/or a display. The user interface 922 may include any element or component that conveys information to a user of the wireless device 902 and/or receives input from the user.

The wireless device 902 may also include the reverse direction component 126 and perform the methods described in FIGS. 5-8 above.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a second device, comprising:
receiving a reverse direction (RD) grant associated with a first device, the RD grant allocating transmission opportunity (TXOP) resources to the second device from the first device;
generating, in response to receiving the RD grant, a control response aggregated with at least one media access control protocol data unit (MPDU); and
transmitting the control response to the first device.

2. The method of claim 1, wherein the at least one MPDU includes an indication that the second device accepts the RD grant to retain control of an RD response burst.

3. The method of claim 2, wherein the indication that the second device accepts the RD grant also indicates that additional frames will be transmitted in response to the RD grant.

4. The method of claim 1, wherein the at least one MPDU is one or more of a quality of service (QoS) Null frame, a QoS data frame, or a management frame.

5. The method of claim 1, wherein the at least one MPDU includes an indication that the second device declines the RD grant.

6. The method of claim 5, wherein the indication that the second device declines the RD grant also indicates that additional frames will not be transmitted in response to the RD grant.

7. The method of claim 1, further comprising receiving, from the first device, an acknowledgment of the control response.

8. A method of wireless communication by a second device, comprising:
generating a reverse direction (RD) exchange request requesting a first device to initiate an RD exchange sequence; and
transmitting the RD exchange request to the first device.

9. The method of claim 8, wherein the RD exchange request is indicated in a quality of service (QoS) Null frame or a QoS data frame.

10. The method of claim 8, further comprising:
generating an indication that the second device supports an RD exchange; and
transmitting, to the first device, the indication that the second device supports the RD exchange.

11. The method of claim 10, wherein the indication that the second device supports the RD exchange request is included in a capabilities element.

12. The method of claim 10, wherein the indication that the second device supports the RD exchange request is indicated through an uplink multi-user setting being disabled.

13. The method of claim 8, further comprising receiving, from the first device in response to the RD exchange request, a confirmation to the RD exchange request.

14. The method of claim 8, wherein the RD exchange request includes a transmission opportunity (TXOP) duration request indicating a duration of a TXOP to be used by the first device during the RD exchange sequence.

15. A method of wireless communication by a first device, comprising:
generating a reverse direction (RD) grant associated with the first device, the RD grant allocating transmission opportunity (TXOP) resources to a second device from the first device;
transmitting, to the second device, the RD grant associated with the first device; and
receiving, in response to the RD grant, a control response aggregated with at least one media access control protocol data unit (MPDU); and
determining whether the RD grant is accepted or declined based on the MPDU.

16. The method of claim 15, wherein the at least one MPDU includes an indication that the second device accepts the RD grant to retain control of an RD response burst.

17. The method of claim 16, wherein the indication that the second device accepts the RD grant also indicates that additional frames are transmitted in response to the RD grant.

18. The method of claim 15, wherein the at least one MPDU is one or more of a quality of service (QoS) Null frame, a QoS data frame, or a management frame.

19. The method of claim 15, wherein the at least one MPDU includes an indication that the second device declines the RD grant.

20. The method of claim 19, wherein the indication that the second device declines the RD grant also indicates that additional frames are not transmitted in response to the RD grant.

21. The method of claim 20, wherein the control response is an RD response burst.

22. A method of wireless communication by a first device, comprising:
receiving, from a second device, a message; and
determining that the message includes a reverse direction (RD) requesting the first device to initiate an RD exchange sequence.

23. The method of claim 22, wherein the RD exchange request is indicated in a quality of service (QoS) Null frame or a QoS data frame received from the second device.

24. The method of claim 22, further comprising receiving, from the second device, an indication that the second device supports an RD exchange.

25. The method of claim 24, wherein the indication that the second device supports the RD exchange is included in a capabilities element.

26. The method of claim 24, wherein the indication that the second device supports the RD exchange request is indicated through an uplink multi-user setting being disabled.

27. The method of claim 22, further comprising determining a duration of a subsequent transmission opportunity (TXOP).

28. The method of claim 22, further comprising transmitting, to the second device in response to the RD exchange request, a confirmation of the RD exchange request.

29. An apparatus for wireless communication, comprising:
a memory; and
at least one processor coupled with the memory and configured to:
receive a reverse direction (RD) grant associated with a first device, the RD grant allocating transmission opportunity (TXOP) resources to the apparatus from the first device;
generate, in response to receiving the RD grant, a control response aggregated with at least one media access control protocol data unit (MPDU); and
transmit the control response to the first device.

30. An apparatus for wireless communication, comprising:
a memory; and
at least one processor coupled with the memory and configured to:
generate a reverse direction (RD) grant associated with the apparatus, the RD grant allocating transmission opportunity (TXOP) resources to a second device from the apparatus;
transmit, to the second device, the RD grant associated with the apparatus; and
receive, in response to the RD grant, a control response aggregated with at least one media access control protocol data unit (MPDU); and
determine whether the RD grant is accepted or declined based on the MPDU.
